(19) United States
(12) Patent Application Publication
(10) Pub. No.: US 2007/0147833 A1
(43) Pub. Date: Jun. 28, 2007

(54) Dynamic wavelength allocation apparatus and method

(76) Inventors: Yun-Hee Cho, Daejeon-city (KR); Kwang-Joon Kim, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/591,214

(22) Filed: Nov. 1, 2006

(30) Foreign Application Priority Data
Dec. 23, 2005 (KR) 10-2005-0128968
Jun. 2, 2006 (KR) 10-2006-0049734

(51) Int. Cl. H04J 14/00

(52) U.S. Cl. 398/57

(57) ABSTRACT

A wavelength allocation method and apparatus that is capable minimizing the number of wavelength converters is provided. In a dynamic wavelength multiplexing division network structure having a limited maximum transmission distance, an optical path is established to maximally suppress activation of a 3R wavelength converter, thereby maximizing efficiency of the 3R wavelength converter. In a dynamic wavelength multiplexing division network structure having a limited maximum transmission distance, a new optical path is established to minimize 3R wavelength conversion and suppress use of unnecessary expensive 3R wavelength converters and thereby increase network efficiency.

### BACKGROUND OF THE INVENTION

(a) Field of the Invention

The present invention relates to a wavelength allocation method and apparatus, and particularly relates to a wavelength allocation method and apparatus capable of using a minimum number of 3R wavelength converters.

(b) Description of the Related Art

In the super high speed optical communication field, a wavelength division multiplexing (WDM) scheme has been used, which includes a plurality of optical channels so as to transmit a large amount of data by a single optical fiber.

The optical communication network is eventually expected to be developed as an All Optical Transmission Network that dynamically reconstructs a network by necessarily changing an optical path of a present linear or circular network in which the data are transmitted through a fixed route.

Particularly, a backbone network may become an Optical Cross-Connector (OXC)-based mesh-type network in which the respective nodes may reconstruct a circuit.

The mesh-typed network of the wavelength division multiplexing scheme requires a wavelength continuity condition in which an input channel has the same wavelength as that of an output channel.

In order to satisfy such a wavelength continuity condition, a wavelength converter is needed. Recently, research results have been published in which network efficiency is largely enhanced by a relatively small number of converters in comparison with the number of optical channels of the respective nodes.

In the mesh-type network of the wavelength division multiplexing scheme, optical signal-transmission quality deterioration as well as the wavelength continuity condition should be considered because a transmission distance is limited due to the optical signal-transmission quality deterioration as well as the wavelength continuity condition.

When the optical signal has a path that departs from a Signal Impairment Threshold (SIT) that may guarantee the transmission quality, such a signal should be processed by regeneration (hereinafter, briefly referred to as “3R regeneration”) of 3 functions (i.e., Re-Amplification, Re-Shaping, and Re-Timing).

In the dynamic wavelength division multiplexing network structure, a maximum of optical path generation requests must be accommodated, so it is important not to waste unnecessary resources when establishing each optical path.

The 3R wavelength converter may have the 3R function and a wavelength conversion function that are capable of changing the specified wavelength channel into other wavelength channels. However, it is expensive to use the 3R wavelength converters, and thus it is impossible for all the nodes to use them so as to support a wavelength conversion for all the wavelength channels.

Accordingly, the dynamic wavelength division multiplexing network structure may be formed such that the 3R wavelength conversion function is provided only in a specified node of the network, or the number of 3R wavelength converters is limited.

At this time, a limited type of wavelength conversion function implies that all the wavelength channels may not be converted, rather only a few wavelength converters are placed at each node and the wavelength conversion function may be performed at only the specified node.

In the wavelength division multiplexing network structure, it may be wasteful for the 3R wavelength converter to be configured such that a full wavelength conversion condition is satisfied, because the number of accommodated wavelengths of one link may be rapidly increased.

In the conventional wavelength division multiplexing network structure having limited wavelength conversion, a wavelength conversion condition having a wavelength conversion function over all the wavelengths at the specified node or a wavelength conversion condition having the limited wavelength conversion function at all the nodes is assumed.

That is, the limited wavelength conversion condition has been studied only in relation to the wavelength converter. In addition, the respective wavelength converters have been configured assuming that they may satisfy the full wavelength conversion condition.

However, actually, in the wavelength division multiplexing network, it is necessary to consider the regeneration function (3R Regeneration) as well as the wavelength conversion function because the optical signal's maximum transmission distance is limited.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a wavelength allocation method and apparatus having advantages of using the minimum number of 3R wavelength converters in a wavelength division multiplexing network structure having a limited maximum transmission distance.

An exemplary embodiment of the present invention provides a wavelength allocation method in a wavelength division multiplexing scheme, including

(a) selecting at least one path set between transmitting/receiving nodes and determining whether there is an optical path generation request;

(b) extracting routing paths of as many as the number of selected path sets between the transmitting/receiving nodes having the optical path generation request;

(c) determining whether there is a wavelength-continued segment set that satisfies a maximum transmission distance for ensuring optical signal transmission quality and having one continued wavelength among the extracted routing paths; and

(d) selecting a path using the smallest index wavelength among the respective wavelength-continued segment sets and performing wavelength allocation to the selected path when there is a wavelength-continued segment set at the step (c). Another embodiment of the present invention provides a wavelength allocation apparatus for minimizing a wavelength conversion in a wavelength division multiplexing scheme-based network structure. the wavelength allocation apparatus includes

Yet another embodiment of the present invention provides a path arranger for selecting at least one path set between transmitting/receiving nodes, and arranging the same in a minimum distance order;

a routing path unit for extracting routing paths of as many as the number of selected path sets between the transmitting/receiving nodes having an optical path request;

a wavelength-continued segment detector for determining whether there is a wavelength-continued segment set that satisfies the maximum transmission distance for ensuring optical signal transmission quality and having an available continued wavelength among the routing paths extracted from the routing path unit; and

a wavelength allocating unit for selecting a path using a wavelength of the smallest index among the wavelength-continued segment set, and performing wavelength allocation.

### BRIEF DESCRIPTION OF THE DRAWINGS

FIG. 1 is a block diagram for schematically illustrating a wavelength division multiplexing network structure according to an exemplary embodiment of the present invention.

FIG. 2 is a block diagram for schematically illustrating an inner configuration of a wavelength allocation apparatus to have the minimum number of 3R wavelength converters according to an exemplary embodiment of the present invention.

FIG. 3 is a flowchart illustrating a wavelength allocation method according to an exemplary embodiment of the present invention.

FIG. 4 illustrates a first exemplary embodiment of a wavelength-continued segment according to an exemplary embodiment of the present invention.

FIG. 5 illustrates a second exemplary embodiment of a wavelength-continued segment according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

When it is described that an element is coupled to another element, the element may be directly coupled to the other element or coupled to the other element through a third element.

Now, according to an exemplary embodiment of the present invention, a wavelength allocation method and apparatus for using the minimum number of 3R wavelength converters is described with reference to FIGs.

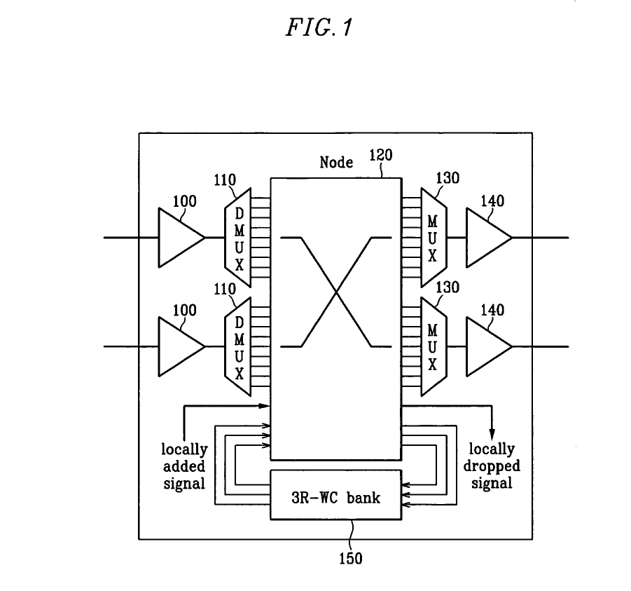

FIG. 1 is a block diagram for schematically illustrating a wavelength division multiplexing network structure according to an exemplary embodiment of the present invention. Respective nodes may be an optical circuit analyzing apparatus, and may become an Add (added signal channel) and a Drop (dropped signal channel).

According to an exemplary embodiment of the present invention, the node includes a first optical power amplifier 100, a wavelength division demultiplexer 110, an optical space switch 120, a wavelength division multiplexer 130, a second optical power amplifier 140, and a 3R wavelength converter 150.

The first optical power amplifier 100 receives an optical signal through an input optical fiber, amplifies the same, and transmits the amplified signal to the wavelength division demultiplexer 110.

The wavelength division demultiplexer 110 separates 1 to N wavelength-division multiplexing optical signals into signal channels corresponding to each wavelength, and outputs the separated signal channels to the optical space switch 120.

The optical space switch 120 receives the signal channels from the wavelength division demultiplexer 110, changes the connection state of the signal channels, and outputs the changed signal channels to the 3R wavelength converter 150 and wavelength division multiplexer 130 or locally drops the same.

The wavelength division multiplexer 130 multiplexes the transmission channels input from the optical space switch 120, and transmits the multiplexed channels to the second optical power amplifier 140.

The second optical power amplifier 140 amplifies the optical signal output from the wavelength division multiplexer 130 and outputs the amplified signal.

All the 3R wavelength converters 150 are shared at the node, and the number of 3R wavelength converters 150 may be in a range of 0 to the number of wavelengths.

The 3R wavelength converter 150 electrically regenerates a signal in an O/E/O (Optical Electricity Optical) scheme, simultaneously provides a 3R regeneration function and wavelength conversion function, and does not limit a range of wavelength conversion (Full Tuning Range).

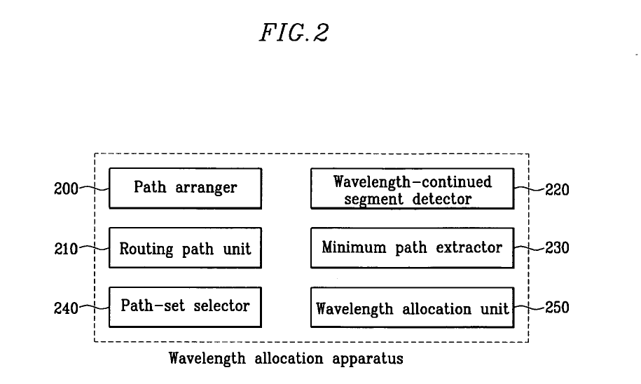

Hereinafter, a wavelength allocation apparatus having the minimum number of 3R wavelength converters in a wavelength division multiplexing network structure is described with reference to FIG. 2.

FIG. 2 is a block diagram for schematically illustrating an inner configuration of a wavelength allocation apparatus to have the minimum number of 3R wavelength converters according to an exemplary embodiment of the present invention.

According to an exemplary embodiment of the present invention, a wavelength allocation apparatus includes a path arranger 200, a routing path unit 210, a wavelength-continued segment detector 220, a minimum path extractor 230, a path set selector 240, and a wavelength allocating unit 250. Herein, the wavelength allocation apparatus may be included in a base station.

The path arranger 200 selects K path sets between all the transmitting/receiving nodes using a Dijkstra's shortest path algorithm, and arranges the selected K path sets in a minimum distance order.

The routing path unit 210 determines whether a new optical path generation request is input and extracts a given K routing paths between the transmitting/receiving nodes inputting the new optical path generation request.

The wavelength-continued segment detector 220 determines whether there is a single path that satisfies the maximum transmission distance and having an available continued wavelength among routing paths extracted from the routing path unit 210, in which the maximum transmission distance guarantees optical signal transmission quality.

The minimum path extractor 230 extracts a path using the minimum number of 3R functions or wavelength conversion functions among the K routing paths when it receives a signal that there is no single path, from the wavelength-continued segment detector 220. In addition, the minimum path extractor 230 extracts the 3R wavelength converter 150 position information and the remaining 3R wavelength converter 150 number information with respect to the extracted respective paths.

The path set selector 240 determines whether there is a path having the minimum number of wavelength-continued segments among all the paths extracted from the minimum path extractor 240. When it is determined that there are a plurality of path sets, the path set selector 240 selects a path set in a short path distance order among the path sets. In addition, the path set selector 240 selects a path set having the maximum number of 3R wavelength converters 150 for connecting the wavelength-continued segments.

The wavelength allocating unit 250 selects a path using the smallest index wavelength (first-fit wavelength) among the selected path sets and allocates a wavelength to the selected path. In addition, when the wavelength allocating unit 250 receives a signal that there is a single path from the wavelength-continued segment detector 220, it selects a path using the smallest index wavelength thereon and allocates a wavelength to the selected path.

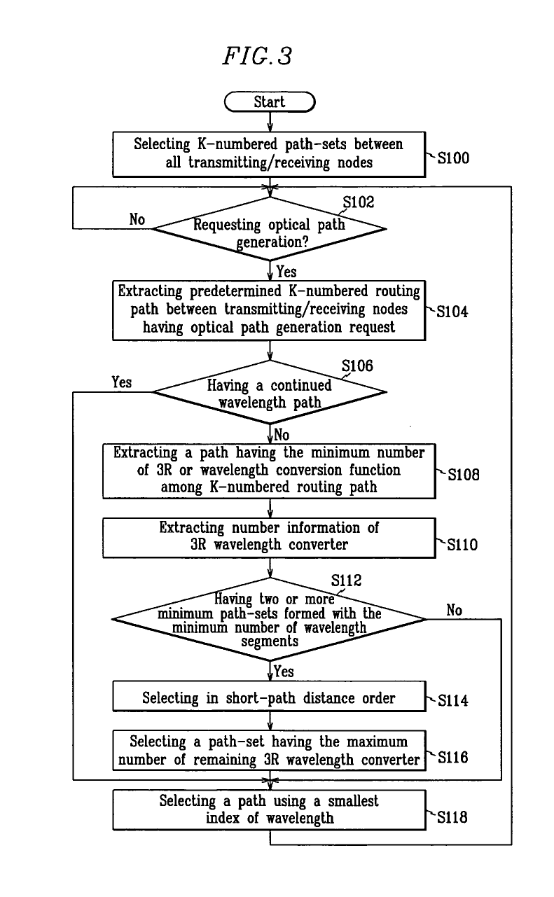

Now, a wavelength allocation method for minimizing 3R wavelength conversion in a wavelength division multiplexing network in which the maximum transmission distance is limited will be described with reference to FIG. 3.

FIG. 3 is a flowchart illustrating a wavelength allocation method according to an exemplary embodiment of the present invention.

The path arranger 200 selects K path sets between all the transmitting/receiving nodes, and arranges the selected path sets in a minimum distance order (S100).

Assuming that the K is given as 5, the base station selects all five paths and arranges the same in a short path distance order.

Such K paths are expressed as Pks,d, in which the path K=1 implies a first minimum path, and the path K=2 implies a next minimum path.

The routing path unit 210 periodically determines whether a new optical path generation request signal is received (S102). When the routing path unit 210 determines that the new optical path generation request signal has been received, it extracts the predetermined K routing paths between the transmitting/receiving nodes (S104). That is, the wavelength allocation apparatus perform the steps S104 to S118 when the new optical path generation request is input.

The wavelength-continued segment detector 220 determines whether there is a path satisfying a maximum transmission distance and having an available continued wavelength among the K routing paths (S106).

The wavelength-continued segment detector 220 determines whether there is a wavelength-continued segment set satisfying a maximum transmission distance ensuring optical signal transmission quality and having an available continued wavelength among the extracted routing paths.

When it is determined at the step S106 that there is no path satisfying the maximum transmission distance and having the one wavelength continued segment, the minimum path extractor 230 extracts all the paths having the minimum number of 3R functions or wavelength conversion functions among the K routing paths (S108).

The minimum path extractor 230 extracts the 3R wavelength converter position information (to confirm whether the 3R wavelength converter is displaced on any node) and the remaining 3R wavelength converter 150 number information with respect to the respective paths extracted at the step S108 (S110). That is, the steps S108 and S110 are for selecting a path set having the minimum number of wavelength-continued segments.

Continuously, the path set selector 240 determines whether there are two or more path sets having the minimum number of wavelength-continued segments through the steps S108 and S110 (S112).

The path set selector 240 selects the above-noted path sets in the short path distance order when it is determined that there are two or more path sets at the step S112 (S114).

The path set selector 240 selects a path set having the maximum number of 3R wavelength converters 150 so as to connect the wavelength-continued segments (i.e., the path set for providing the most uniform distribution to the available 3R wavelength converter 150) (S116).

The wavelength allocating unit 250 selects a path using the smallest index wavelength (first-fit wavelength) among the path sets and allocates a wavelength to the selected path (S118).

The wavelength allocating unit 250 selects a path using the smallest index wavelength among the wavelength-continued segment sets and performs wavelength allocation to the selected path.

When it is determined that there is a path satisfying the maximum transmission distance and having the wavelength-continued segment at the step S106, the wavelength allocating unit 250 selects a path using the smallest index wavelength and allocates a wavelength to the selected path (S118).

When it is determined that there is one path set at the step S112, the wavelength allocating unit 250 selects a path using the smallest index wavelength among the path sets and allocates a wavelength to the selected path (S118).

Such a wavelength-continued segment implies that the wavelength channel of the idle state is continuously placed on the routing path.

The optical path between the transmitting/receiving nodes may sequentially pass the wavelength-continued segment.

The most ideal optical path may be formed in the case that the single wavelength-continued segment is between the transmitting/receiving nodes, and a distance therebetween is less than the maximum transmission distance provided in a wavelength division multiplexing network.

Such an optical path may not use a wavelength converter because the corresponding optical path is accommodated in the one continued wavelength channel.

When there is no path having the one wavelength-continued segment (the transmitting and receiving nodes are not connected through the one wavelength-continued segment), the optical path must be accommodated by passing a plurality of wavelength-continued segments, and must use the 3R wavelength converter 150 in order to be passed from one wavelength-continued segment to another wavelength-continued segment.

According to an exemplary embodiment of the present invention, the wavelength allocation method for minimizing a 3R wavelength conversion includes limiting the maximum transmission distance for ensuring an optical signal transmission quality, performing regeneration using the 3R wavelength converter 150 when it exceeds the maximum distance, and If not, being blocked.

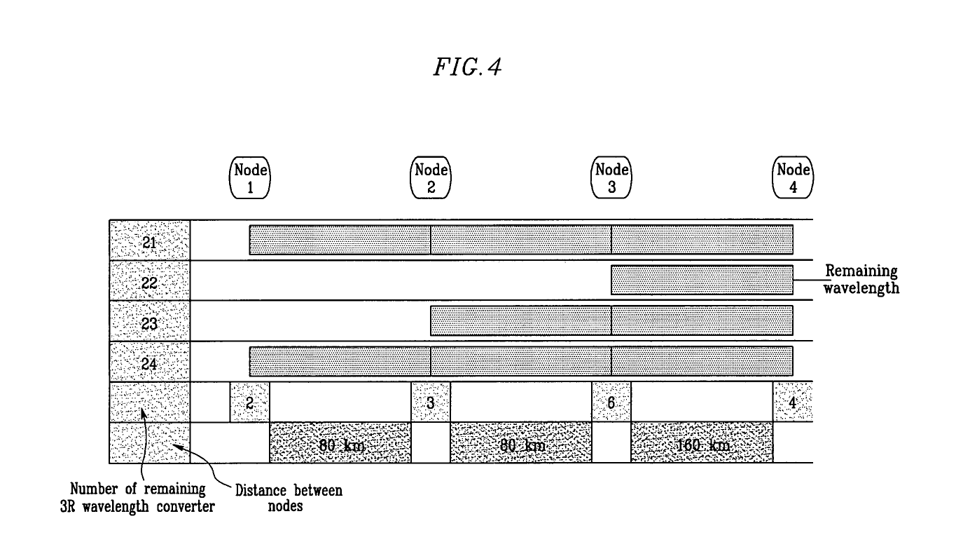

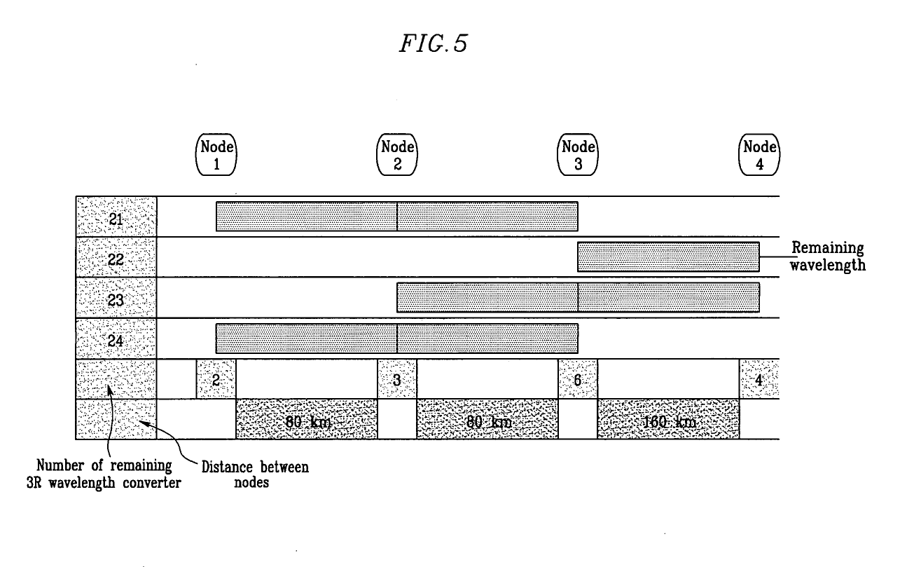

Hereinafter, in FIG. 4 and FIG. 5, it is assumed that K=1, the transmitting node s=1, and the receiving node d=4.

The predetermined routing path between the transmitting and receiving nodes is given as N1−>N2−>N3−>N4. The maximum transmission distance is given as 240 Km in a wavelength division multiplexing network.

A distance sum of the respective wavelength-continued segments must be established to be less than 240 Km.

When a path from the node 1 to the node 4 is given as node 1−>80 Km−>node 2−>80 Km−>node 3−>160 Km−>node 4, the continued wavelength λ1 is present on the routing path. However, the wavelength-continued segment may be divided into (node 1−>node 2−>node 3), (node 3−>node 4) or (node 1−>node 2), (node 2−>node 3−>node 4).

In FIG. 4, the idle wavelength is used in Pk=1s=1 and d=4, and the state of the 3R wavelength converter 150−>the 3R wavelength converter 150 having a 3R function.

In FIG. 4, the idle wavelength is used in Pk=1s=1 and d=4, and the state of the 3R wavelength converter 150−>the 3R wavelength converter 150 having a 3R function and a wavelength conversion function.

FIG. 4 illustrates a first exemplary embodiment of a wavelength-continued segment according to an exemplary embodiment of the present invention.

The wavelength allocation apparatus determines whether there is a path (without using a 3R function and a wavelength conversion function) satisfying the maximum transmission distance and having an available continued wavelength among the K routing paths.

The N1−>N2−>N3−>N4 have a continued wavelength, but do not satisfy the maximum transmission distance.

Accordingly, when it is determined that there is no path satisfying the maximum transmission distance and having the available continued wavelength, the wavelength allocation apparatus searches all the wavelength-continued segment sets using the minimum number of 3R functions or wavelength conversion functions among the K paths.

That is, the wavelength sequential segment sets of {(N1, N2, N3), (N3, N4)}, {(N1, N2), (N2, N3, N4)} are selected.

The wavelength allocation apparatus selects a wavelength-continued segment set having a maximum number of the remaining 3R wavelength converters 150 because there are pluralities of paths using the minimum number of 3R wavelength converters 150.

That is, the wavelength sequential segment sets of =>{(N1, N2, N3), (N3, N4)} are selected.

The wavelength allocation apparatus selects a path using the smallest index wavelength (first-fit wavelength) in the selected wavelength-continued segment sets and allocates the wavelength to the selected path.

That is, the wavelength sequential segment sets of =>{(N1, N2, N3)−>λ1, (N3, N4)−>λ1} are selected.

FIG. 5 illustrates a second exemplary embodiment of a wavelength-continued segment of according to an exemplary embodiment of the present invention.

The wavelength allocation apparatus determines whether there is a path (without using a 3R function and wavelength conversion function).satisfying the maximum transmission distance and having the available continued wavelength among the K routing paths. However, as shown in FIG. 4, such a path is absent.

Accordingly, the wavelength allocation apparatus searches all the wavelength-continued segment sets using the minimum number of 3R functions or wavelength conversion functions among the K paths.

That is, the wavelength sequential segment sets of {(N1, N2, N3), (N3, N4)}, {(N1, N2), (N2, N3, N4)} are selected.

The wavelength allocation apparatus selects a wavelength-continued segment set having the maximum number of the remaining 3R wavelength converters 150 because there are the pluralities of paths using the minimum number of 3R wavelength converters 150.

That is, the wavelength sequential segment set of {(N1, N2, N3), (N3, N4)} is selected.

The wavelength allocation apparatus selects a path using the smallest index of wavelength (first-fit wavelength) in the selected wavelength-continued segment set and allocates the wavelength to the selected path.

That is, the wavelength sequential segment sets of =>{(N1, N2, N3)−>λ1, (N3, N4)−>λ2} are selected.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to an exemplary embodiment of the present invention, in a wavelength division multiplexing network structure having a limited maximum transmission distance, a new optical path may be established to minimize a number of 3R wavelength conversions, and accordingly, the use of the unnecessary expensive 3R wavelength converters is suppressed and the efficiency of the network application is enhanced. In addition, on the accommodation of the optical path, service disruption due to wavelength collisions may be reduced.

What is claimed is:

1. A wavelength allocation method in a wavelength division multiplexing scheme, comprising:
(a) selecting at least one path set between transmitting/receiving nodes and determining whether there is an optical path generation request;
(b) extracting routing paths of as many as the number of selected path sets between the transmitting/receiving nodes having the optical path generation request;
(c) determining whether there is a wavelength-continued segment set that satisfies a maximum transmission distance for ensuring optical signal transmission quality and having one continued wavelength among the extracted routing paths; and
(d) selecting a path using the smallest index wavelength among the respective wavelength-continued segment sets and performing wavelength allocation to the selected path when there is a wavelength-continued segment set at the step (c).

2. The wavelength allocation method of claim 1, further comprising:
extracting a minimum path using the minimum number of regeneration or wavelength conversion functions among the extracted routing paths at the step (c);
selecting a minimum path set having the minimum number of wavelength-continued segments by extracting the 3R wavelength converter-position information and the remaining 3R wavelength converter number information among the extracted minimum paths;
selecting a minimum path set in a short-path order among the selected minimum path sets when there are two or more selected minimum path sets; and
selecting the minimum path set having the maximum number of the 3R wavelength converters among the selected minimum path sets.

3. The wavelength allocation method of claim 1, wherein at step (a), the at least one selected path set is arranged in a minimum-distance order.

4. The wavelength allocation method of claim 2, further performing wavelength allocation by selecting a path using the smallest index of wavelength when there are not two or more selected minimum path sets.

5. A wavelength allocation apparatus for minimizing a wavelength conversion in a wavelength division multiplexing scheme-based network structure, the wavelength allocation apparatus comprising:
a path arranger for selecting at least one path set between transmitting/receiving nodes, and arranging the same in a minimum distance order;
a routing path unit for extracting routing paths of as many as the number of selected path sets between the transmitting/receiving nodes having an optical path request;
a wavelength-continued segment detector for determining whether there is a wavelength-continued segment set that satisfies the maximum transmission distance for ensuring optical signal transmission quality and having an available continued wavelength among the routing paths extracted from the routing path unit; and
a wavelength allocating unit for selecting a path using a wavelength of the smallest index among the wavelength-continued segment set, and performing wavelength allocation.

6. The wavelength allocation apparatus of claim 5, wherein the routing path is selected in consideration of the regeneration function and the wavelength conversion function.

7. The wavelength allocation apparatus of claim 5, further comprising a minimum path extractor for extracting a minimum path using the minimum number of regeneration functions or the wavelength conversion functions among the extracted routing paths and for extracting the 3R wavelength converter-position information and the remaining 3R wavelength converter number information in the extracted routing path.

8. The wavelength allocation apparatus of claim 7, further comprising a path set selector for selecting a path set having the minimum number of wavelength-continued segments among the paths extracted from the minimum path extractor and selecting the same in a short-path distance order and in the maximum number of remaining 3R wavelength converter order.
